(19) United States
(12) Patent Application Publication
(10) Pub. No.: US 2004/0132447 A1
(43) Pub. Date: Jul. 8, 2004

(54) Fixed wireless access system

(76) Inventors: Jan Hirschfeld, Gustavsberg (SE); Guillermo Lafarga, Vizcaya (ES)

Correspondence Address: NIXON & VANDERHYE, PC, 1100 N GLEBE ROAD, 8TH FLOOR, ARLINGTON, VA, 22201-4714, US

(21) Appl. No.: 10/472,176

(22) PCT Filed: Mar. 19, 2002
(86) PCT No.: PCT/SE02/00555

(30) Foreign Application Priority Data
Mar. 21, 2001 (SE) 0101019-8

(51) Int. Cl. H04Q 7/20; H04B 1/38; H04M 1/00

(52) U.S. Cl. 455/426.2; 455/569.1

(57) ABSTRACT

A communication system including PSTN and a mobil communication network (1) where the mobile communication network is connected to a fixed cellular terminal (3) and a cable from said terminal is arranged to a fixed standard telephone (5) which forms a first user interface to a subscriber wishing to make a call or take a call. The fixed cellular terminal (3) includes means for radio communication (2) with at least one hands free headsets (6) which forms a second user interface to said subscriber, which give said subscriber the opportunity to make a call and take a call according to first or second of said interface.

The present invention relates to a communication system including PSTN and a mobil communication network where the mobile communication network is connected to a fixed cellular terminal and a cable from said terminal is arranged to a fixed standard telephone which forms a user interface to a subscriber wishing to make a call or take a call.

Many telecommunications operators have subscribers that want to have fixed standard telephones to their homes and offices. When the operator don't have a fixed wire to offer he need to have a solution that fulfils the customer's demands. One such solution with a fixed cellular terminal connected to the mobile network is described in U.S. Pat. No. 5,991,641.

Another state of the art that is close to the invention is the concept of Bluetooth technology that was originally developed as a means of connecting mobile phones to accessories without wires. Bluetooth is an universal radio interface operating within the ISM band. An example of such a radio interface is called Bluetooth (see the Telecommunications Technology Journal “Ericsson Review”, No. 3 1998, with the article “BLUETOOTH-The universal radio interface for ad hoc, wireless connectivity” by Jaap Haartsen).

A Fixed Cellular Terminal seamlessly bridges the gap between landline telephone systems and the telephone network by enabling the operator to utilise the cellular telephone network with the operators landline system. A fixed cellular terminal give the operator instant fixed wireless communications wherever land lines are unavailable, unreliable, or uneconomical and save the operator money on expensive landline to cellular airtime charges by routing calls directly over the cellular network.

Since fixed subscribers generally call more and usually longer there is a still need for operators to provide subscribers with fixed standard telephones at places where wires not are available. Most of the fixed phones today are developed under a very long time and many subscribers are familiar to talk and use the phones. The phones normally have big buttons to press when a subscriber shall make a call so many people think it is a really nice thing to handle compared to small mobile phones especially when they want to speak in the phone for a long time. However, want these subscribers, who still like the fixed standard phone better than a mobile phone, because of its simple handling, mobility so they can walk around, in the house, office or department from time to time. They also normally want to have just one bill for their calls and they also want to be reached under one telephone number and from time to time they want to use the value-added services that can be available in the mobile network.

Therefor it is an object of the present invention to provide telecommunication operators with a better infrastructure solution, which meets the demands of the subscriber.

It is a further object of the present invention to give the subscriber a second user interface, which give a fixed subscriber mobility in a limited area.

It is a further object of the invention to give the subscriber a second user interface that is simple to use so that the subscriber can make a call with his voice.

According to a one aspect of the present invention is a communication system including PSTN and a mobil communication network where the mobile communication network is connected to a fixed cellular terminal and a cable from said terminal is arranged to a fixed standard telephone which forms a first user interface to a subscriber wishing to make a call or take a call. The fixed cellular terminal includes means for radio communication with at least one hands free headsets which forms a second user interface to said subscriber, which give said subscriber the opportunity to make a call and take a call according to first or second of said interface.

said means for radio communications includes a Bluetooth module which communicate according to the Bluetooth Specification.

said headset includes Bluetooth chip which communicate according to the Bluetooth specification.

Advantages from the invention is stated later in the description but one main advantages with the communication system according to the invention is that telecommunication operators can offer their fixed subscriber mobility that are almost comparably with the subscriber in the mobile net which uses mobile phones.

Embodiments of the invention will now be described, by way of example, with reference to the accompanying drawings, in which:

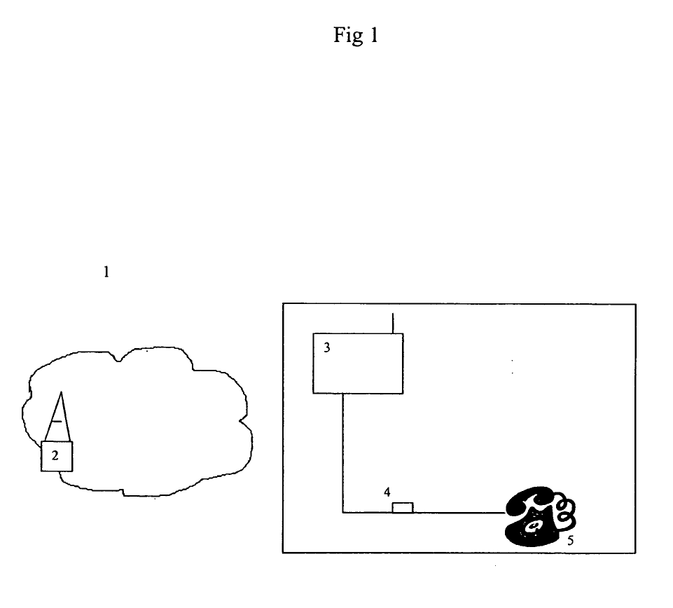

FIG. 1 illustrates the state of the art.

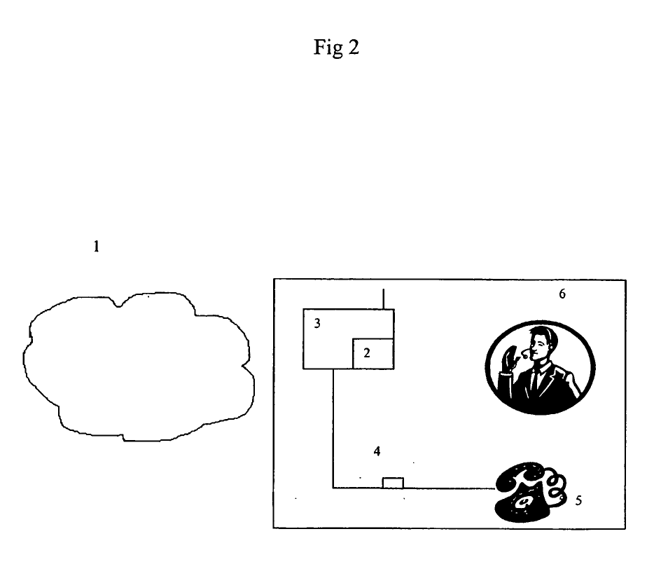

FIG. 2 illustrates the invention.

A glossary of the abbreviations used in this patent specification is set out below to facilitate an understanding of the present invention.

ISM—Industrial, Scientific and Medical band.

GSM—Group System Mobile— The cellular network

UMTS—Third generation mobile network

PSTN—Public Switched Telephone Network

The present embodiment of the invention relates to a communication system which give a fixed wired subscriber two user interface when the subscriber want to make a call or take a call.

The invention is based on an general known concept which give a subscriber one interface which is illustrated in FIG. 1. In FIG. 1 we have the mobil network (1) which is the GSM-network (which is connected to the PSTN— not shown in the figue) and a basestation (2) which transmits a call from the basestaion (2) to a fixed cellular terminal (3) which is equipped with an small antenna and is mounted on a wall in some sort of building. From the fixed cellular terminal is arranged a wire to a subscriber telephone socket (4). From the socket we have a wire to a standard touch tone telephone. This telephone represents the interface for a subscriber which want to use a standard touch tone telephone and dial a number in a conventional manner. The subscriber hears the dial tone when he starts to dial. This is a flexible solution for integrating a landline telephone system with for example a GSM 900 network, giving a subscriber standard telephone access to home, office, or any other remote location where phone service is needed and a GSM 900 network is available.

In FIG. 2 is illustrated an embodiment according to the invention.

The FIGURE illustrates a communication system including PSTN (not shown in the FIGURE) and a mobile communication network (1) which can be a network according to GSM or UMTS. The mobile communication network (1) is connected to a fixed cellular terminal (3) and a cable from said terminal is arranged via a telephone socket (4) to a fixed standard telephone (5). Said telephone forms a first user interface to a subscriber wishing to make a call or take a call.

The fixed cellular terminal (3) includes means for radio communication which is a Bluetooth module that communicate at least with one hands free headsets, that include a bluetooth microchip. The headset forms a second user interface to said subscriber, which give said subscriber the opportunity to make a call and take a call according to first or second of said interface. The principles of communicating with bluetooth are described later in the description.

The bluetooth headset (6) is a lightweight, wireless headset with a built-in Bluetooth radio chip that functions as a connector between the headset (6) and a Bluetooth module (2) in the fixed cellular terminal (3). The headset also includes a small sized loudspeaker and microphone. To answer or initiate a call the subscriber presses a key on the headset (not shown in the FIGURE). The Bluetooth radio link covers distances up to 10 meters (in special implementations 100 meters). Weighing around 20 grams, the Bluetooth Headset sits comfortable on either ear.

The bluetooth module which is integrated in the Fixed cellular terminal (3) includes radio frequency (RF) and baseband circuits, FLASH memory, and a associated software stack.

A subscriber who wants to make a call has two options in the communication system according to the invention. He can either choose to press the buttons on the standard telephone or use his voice to activate the additional functionality which he can find in he cellular net. When he uses the headset for dialling he just say a “magic word” and then the enhanced voice recognition in the fixed cellular terminal or in the mobile network makes it possible to “wake up” the headset from a standby mode, making it receptive to voice commands. In this way, there's no need to press any buttons on the fixed touch tone telephone, making it easy to use even when walking around in for example a building. In that way the subscriber have the opportunity to even make a call from the headset.

A subscriber who want to take a call have also two opportunities to take the call either he can take the call by using the standard telephone in a conventional manner or so can he switch the button on the headset to take the call.

The communication system makes it possible for the subscriber to have to interfaces when he want to answer a call or make a call and since he only has to have one agreement with one operator he probably only get one bill from his operator and he can be reached under one number to his two interface.

In an additional embodiment of the invention the subscriber can have several headsets for example a hole family and everyone in the family that has a headset can make a call and take a call.

Bluetooth wireless technology is a low-cost, low-power, short-range radio link for mobile devices and for WAN/LAN access points. It offers fast and reliable digital transmissions of both voice and data over the globally available 2.4 GHz ISM band. The Bluetooth Specification is a de facto standard containing the information required to ensure that diverse devices supporting the Bluetooth wireless technology can communicate with each other world-wide and the Bluetooth radio is built into a small microchip.

The Bluetooth specification has two power levels defined; a lower power level that covers the shorter personal area within a room, and a higher power level that can cover a medium range, such as within a home. Software controls and identity coding built into each microchip ensure that only those units present by their owners can communicate.

A frequency hop transceiver is applied to combat interference and fading. Also, a shaped, binary FM modulation is applied to minimize transceiver complexity. The symbol rate is 1 Mb/s and a slotted channel, with a nominal slot length of 625 us is applied. For full duplex transmission, a Time-Division Duplex (TDD) scheme is used, while on the channel, information is exchanged through packets. A packet is normally transmitted on a different hop frequency, but it can be extended to cover up to five slots.

The Bluetooth protocol uses a combination of circuit and packet switching, and slots can be reserved for synchronous packets. Bluetooth wireless technology can also support an asynchronous data channel, up to three simultaneous synchronous voice channels, or a channel that simultaneously supports asynchronous data and synchronous voice. Each voice channel supports a 64 kb/s synchronous (voice) channel in each direction. The asynchronous channel can support a maximal 723.2 kb/s asymmetric, and up to 57.6 kb/s in three return direction, or 433.9 kb/s symmetric.

The Bluetooth system consists of a radio, a baseband, link management, and host terminal interface functions. The Bluetooth system provides a point-to-multipoint connection and the channel is shared among several Bluetooth units. Two, or more units sharing the same channel form a piconet, while one Bluetooth unit acts as the master of the piconet, the other unit(s) act as slave(s). Up to seven slaves can be active in the piconet, and many more can remain locked to the master in a parked state. These parked slaves cannot be active on the channel but remain synchronised to the master. For both active and parked slaves, the master controls channel access.

The Bluetooth wireless technology supports both point-to-point and point-to-multipoint connections. With the current specification, up to seven slaves devices can be set to communicate with a master radio in one device. Several of these piconets can be established and linked together in ad hoc scatternets to allow communication among continually flexible configurations. All devices in the same piconet have priority synchronization, but other devices can be set to enter at any time. The topology can best be described as a flexible, multiple piconet structure.

The invention shall not be limited to the shown embodiment but can be freely varied within the scope of the appended claims. For example, the arrangement does not have to be used in combination with the Bluetooth standard but with any convenient system or standard.

1. A communication system including PSTN and a mobil communication network (1) where the mobile communication network is connected to a fixed cellular terminal (3) and a cable from said terminal is arranged to a fixed standard telephone (5) which forms a first user interface to a subscriber wishing to make a call or take a call, characterized in that the fixed cellular terminal (3) includes means for radio communication (2) with at least one hands free headsets (6) which forms a second user interface to said subscriber, which give said subscriber the opportunity to make a call and take a call according to first or second of said interface.

2. A communications system according to patent claim 1, characterized in that means for radio communications (2) includes a Bluetooth module which communicate according to the Bluetooth Specification.

3. A communications system according to patent claim 1, characterized in that the headset (6) includes Bluetooth chip which communicate according to the Bluetooth specification.

4. A communications system according to patent claim 2, characterized in that the Bluetooth module includes radio frequency (RF) and baseband circuits, FLASH memory, and a associated software stack.

5. A communications system according to patent claim 3, characterized in that the headset includes a transceiver, microphone and loudspeaker.

6. A communications system according to patent claim 1, characterized in that a fixed subscriber who is connected to a telephone socket (4) have a second user interface which give the subscriber mobility.

7. A communications system according to patent claim 6, characterized in that a subscriber who want to make a call has two options he can either choose to press the buttons on the standard telephone or use his voice to activate the additional functionality which he can find in he cellular net.

8. A communications system according to patent claim 7, characterized in that when he uses the headset for dialling he just say a “magic word” and then the enhanced voice recognition in the fixed cellular terminal or in the mobile network makes it possible to “wake up” the headset from a standby mode, making it receptive to voice commands.

9. A communications system according to patent claim 1, characterized in that the subscriber can be reached under one number to his two interface.

10. A communications system according to patent claim 1, characterized in that a subscriber who want to take a call have two opportunities to take the call either he can take the call by using the standard telephone in a conventional manner or so can he switch the button on the headset to take the call.
